(19) United States
(12) Patent Application Publication
(10) Pub. No.: US 2007/0047717 A1
(43) Pub. Date: Mar. 1, 2007

(54) Telephone record search system

(76) Inventors: Charles Ho, Plano, TX (US); Ming Yu, Plano, TX (US); Betty Li, Plano, TX (US); Dwayne E. Morton, Dallas, TX (US)

Correspondence Address: Peter J. Thoma, Suite 3300, 1700 Pacific Avenue, Dallas, TX, 75201, US

(21) Appl. No.: 11/503,726

(22) Filed: Aug. 14, 2006

Related U.S. Application Data
(60) Provisional application No. 60/710,811, filed on Aug. 25, 2005.

(51) Int. Cl. H04M 3/42

(52) U.S. Cl. 379/218.01

(57) ABSTRACT

A universal database of telephone numbers of the Public Switched Telephone Network operating under the North American Numbering Plan is created and updated regularly to reflect the most current name and telephone information for telephone subscribers. The database is updated by a system that accesses telephone company subscriber databases through a high-speed connection such as a T1 line that permits modification of the outgoing Calling Party Number (CPN) message field to include any telephone number that the system is interested in searching. By placing a call to a destination line belonging to the system and inserting a telephone-number-in-question (TNIQ) into the CPN message field, the system receives the subscriber name associated with the TNIQ as part of the Caller ID data reported by the telephone company on the destination line between the first and second rings of the incoming call. The system can then store the identified subscriber name in the universal database, terminate the incoming call without answering, and then proceed to execute additional query calls. The universal database is made available to customers for searching through the Internet as part of a fee-based search service.

### RELATED APPLICATION

This application claims priority from prior U.S. provisional application Ser. No. 60/710,811 filed Aug. 25, 2005.

### BACKGROUND OF THE INVENTION

The present invention relates generally to the creation and maintenance of telephone directory data and access to such data through telecommunications networks, and more particularly to systems for providing telephone record search services to customers through the Internet.

Internet search services for finding telephone listings for individuals are well known. Some Internet sites offer “white pages” searching free, relying solely on advertising revenue for income. Typically, such free on-line search services use telephone directory databases that are updated infrequently, thus often providing outdated or inaccurate information. Telephone companies provide accurate local and nationwide directory assistance services for a fee through voice telephone lines. However, such directory assistance services are relatively expensive and cumbersome to use.

The present invention addresses the need for accurate and efficient telephone record search services.

### SUMMARY OF THE INVENTION

A principal object of the invention is to provide a system for creating and maintaining a universal database of all telephone numbers of the Public Switched Telephone Network operating under the North American Numbering Plan. The universal database should be updated regularly to reflect the most current and accurate information possible about the identity of telephone subscribers.

A further object of the invention is the inclusion in the universal database of the names of subscribers that are reported by telephone companies using caller ID technology, including subscriber names for cellular telephones and unlisted telephone numbers.

A further object of the invention is the provision of an Internet accessible telephone number database that can be searched online by customers.

The novel features that characterize the invention are set forth in the appended claims. The nature of the invention, however, as well as its advantages, may be understood more fully upon consideration of the following illustrative embodiments, when read in conjunction with the accompanying drawings.

### BRIEF DESCRIPTION OF THE DRAWINGS

FIG. 1 is a simplified block diagram of the national telephone system for the Unites States;

FIG. 2 is block diagram of a system for creating and updating a universal telephone number database, which is searchable by customers through Internet access, according to a first embodiment of the present invention;

FIG. 3 is a flowchart showing how Caller ID data for telephone company subscribers can be acquired through use of the system of FIG. 2; and

FIG. 4 is block diagram of a system for creating and updating a universal telephone number database, which is searchable by customers through Internet access, according to a second embodiment of the present invention.

### DETAILED DESCRIPTION OF THE INVENTION

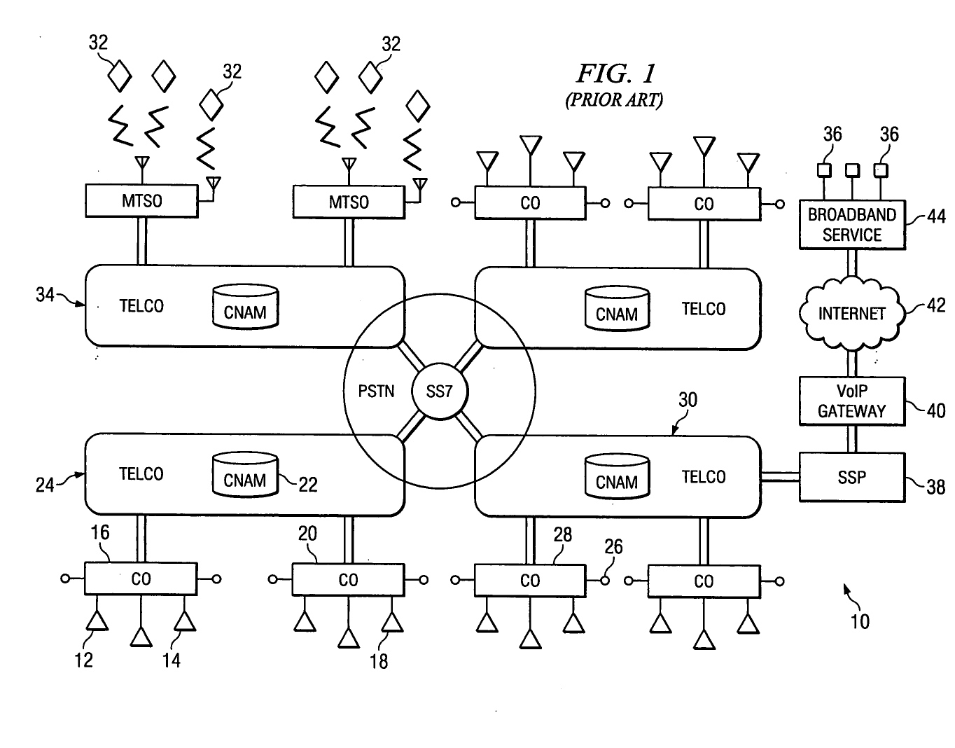

With reference to FIG. 1, relevant components of the telephone system existing in the United States are shown and designated generally by reference numeral 10. At the heart of the system 10 is the Public Switched Telephone Network (PSTN), which primarily comprises the interconnected collection of local and long distance networks of various telephone companies, several examples of which are each designated as a “TELCO” in FIG. 1. At present, the major telephone companies with principal operations in the United States include: Bell South, SBC, Qwest, and Verizon. More broadly, the PSTN can be considered to include all telephone companies operating under the under the North American Numbering Plan (NANP), which includes telephone companies operating in the United States and its territories, Canada, Bermuda, and various participating Caribbean nations.

The NANP is based on telephone numbers that are ten digits in length, the first three digits being the Number Plan Area (NPA), which is commonly called the “Area Code,” the next three digits being the local exchange prefix, which typically corresponds to a Central Office (CO) and is sometimes referred to as the “NXX” number, and the last four digits being the subscriber line number. Thus, each telephone number in the NANP has the format: NPA-NXX-XXXX. Not all three-digit combinations for the NPA are possible Area Codes. For example, a leading “0” is used for operator assistance, and a leading “1” is used for direct dialing of a long distance call. Also, certain sequences are used for special purposes, such as “411” for local directory assistance, and “911” for emergency response services. And in the NXX local exchange prefix, the “N” can only be a number from 2 to 9, while each “X” can be any number from 0 to 9.

Overlaid on, and an integral part of, the PSTN is the Signaling System 7 (SS7), which is a digital network that facilitates phone call interconnections between Telcos by transmitting call routing information. The SS7 network also transmits information used for certain subscriber services, such as providing calling party identification data or “Caller ID” data.

Typically, a Telco provides residential and small business telephone service to its subscribers through a “local loop” connection between the subscriber's telephone set and the local exchange or CO responsible for the subscriber's NXX number. Each CO is a complex switch capable of communicating with various types of subscriber equipment in different signal formats, and connecting outgoing and incoming voice and data traffic to other destinations through the PSTN. Each of three of the Telcos in FIG. 1 is shown as operating a pair of CO switches (many more exist in practice). Each CO switch is connected to a large number of local-loop subscriber telephone sets, a few of which are depicted by the triangle symbols. Larger entities, which are depicted as small circles, often communicate with their CO using a high-speed digital trunk line, commonly referred to as a “T1” line. Such entities might have their own internal switching system such as a Private Branch Exchange (PBX), which might use a more sophisticated connection means to the local CO, such as fiber optic cable.

The Telco in the upper left-hand corner of FIG. 1 is a cellular phone service provider. It will be appreciated that an individual Telco might provide both wireline phone service using conventional CO connections to subscribers and wireless phone service using a cellular network to communicate with cell phone users. The diamond shaped symbols in FIG. 1 represent cell phones that communicate with cellular phone service providers by radio-frequency transmission to and from antennas located on geographically-spaced cellular towers, known as base stations or cells. A Mobile Telephone Switching Office (MTSO) services a grid of base stations and communicates with the operating cellular Telco.

A relatively new platform for telephone service is through the Internet, which is depicted at the right of FIG. 1, and referred to as Voice over Internet Protocol (VoIP). Individual subscribers (represented by small squares) connect to the Internet using a broadband service, such Digital Subscriber Line (DSL) service offered by Telcos, or a cable connection provided by a cable television company. A VoIP service provider converts the format of the digital signals it receives through the Internet to PSTN-compatible digital signals using a Gateway, which is connected to a switch known as a Signal Switching Point (SSP). The SSP functions like a Central Office switch for VoIP call traffic.

Each Telco has multiple databases, some of which store subscriber information. FIG. 1 depicts a special CNAM database associated with each Telco that stores the subscriber's name associated with each telephone number assigned to the particular Telco. The acronym “CNAM” is derived from Caller ID with name. Caller ID data has two components: (1) the Calling Party Number or CPN; and (2) the Caller Name or CNAM. If a telephone set is equipped to receive and display Caller ID data, and the data is available to the Called Party's Telco, both components will ordinarily be displayed between the first and second rings of the incoming call. A Call Block feature is available to the Calling Party, which prevents Caller ID data from being displayed. This is an optional subscriber feature that can be invoked by simply pressing *67 before placing an outgoing call, in which case the Called Party's Caller ID display will typically readout “ID Unavailable” or a similar message. If a call is placed from a telephone with an unlisted phone number, typically the CPN but not CNAM will be displayed. The term “unlisted number” is used herein to mean a phone number that the subscriber has opted not to have listed in its Telco's paper phone directory or be given out to callers to directory assistance.

The following examples illustrate how Caller ID data is transmitted and displayed for typical subscribers who have listed phone numbers and do not block the Caller ID for their outgoing calls.

### EXAMPLE 1

John Subscriber, who has a phone 12 with the number 987-654-3210 (which is fictitious and used as an example), calls his sister Mary Subscriber, who has a phone 14. Their phones are each served by the same CO 16, which includes registers that store the CNAM data for all its local-loop subscribers. When the CO 16 makes the connection between John's phone and Mary's phone, it transmits John's CPN (987-654-3210) and CNAM (“John Subscriber”) on Mary's line for display.

### EXAMPLE 2

John Subscriber, who has a phone 12 served by CO 16, calls his brother Mike Subscriber, who has a phone 18 served by CO 20. When the connection between the two Central Offices is made, Mike's CO 20 receives John's CPN, makes a connection with Mike's phone 18, and recognizes that Mike's phone is equipped with a Caller ID device. Mike's CO 20 makes a query to the CNAM database 22 maintained by Telco 24 asking for the CNAM data corresponding to John's CPN. Since Telco 24 operates both involved Central Offices, its CNAM database 22 includes the CNAM data for both parties to this particular call. Telco 24 responds to the query from Mike's CO 20 by supplying John's CNAM data, which Mike's CO 20 then reports out on Mike's line along with John's CPN for display by Mike's telephone set.

### EXAMPLE 3

John Subscriber, who has phone 12 served by CO 16, makes a long distance call to his friend Paul Employee, who works for Big Company, which has a PBX 26 connected to CO 28 by a fiber optic cable. Big Company has subscribed with Telco 30, which operates CO 28, for Caller ID service for a flat monthly fee. Telco 30 queries Telco 24 through the SS7 network for CNAM data corresponding to John's CPN. Telco 24 searches its CNAM database 22, locates John's CNAM data, transmits it to Telco 30, and books a charge against the account of Telco 30 for searching its CNAM database. Telco 30 transmits John's Caller ID data to CO 28, which transmits it to Big Company's PBX 26 immediately after connecting the call. Big Company's PBX 26 is programmed to display the incoming Caller ID data on Paul's line for display by Paul's telephone set at his desk.

### EXAMPLE 4

Following the call made in Example 3, Paul Employee, who was not at his desk when John Subscriber called, checks his phone and sees from the recorded Caller ID data that he missed a call from his friend John, even though John did not leave a voicemail message. Paul returns the call. Big Company's PBX 26 is programmed to include Paul's direct dial number in the outgoing message sent to its CO 28. As part of its subscription with Telco 30, Big Company can send Automatic Number Identification (ANI) data through its PBX when outgoing calls are placed. In the case of Paul's call to John, Telco 30 transmits the ANI data (Paul's direct dial number) through the SS7 network to Telco 24 and then to John's CO 16. When CO 16 connects the call to John's phone, it transmits Paul's direct dial number as CPN data for display by John's telephone set.

### EXAMPLE 5

Karen Lawyer, who has a cell phone 32 located in an area served by Telco 34, calls her client Bob Executive at his home in another city. Bob has recently subscribed with a VoIP telephone company to provide residential telephone service through Bob's cable television connection. Bob's telephone set, which includes a Caller ID display, is designated by numeral 36 in FIG. 1. Telco 34 connects Karen's outgoing cell phone call to the PSTN through which it is routed to Bob's local Telco 30. Telco 30 recognizes Bob's destination number as one served by SSP 38, to which it connects the call. SSP 38 recognizes Bob's number as having caller ID service, and queries Telco 34 through the SS7 network to obtain Karen's Caller ID data. VoIP Gateway 40 converts the incoming digital voice signals and Caller ID data to an Internet-compatible signal format, and sends the signals through the Internet 42 to Bob's telephone set through Bob's cable company connection 44. Bob's telephone rings and his telephone set displays “Karen Lawyer” and her cell phone number.

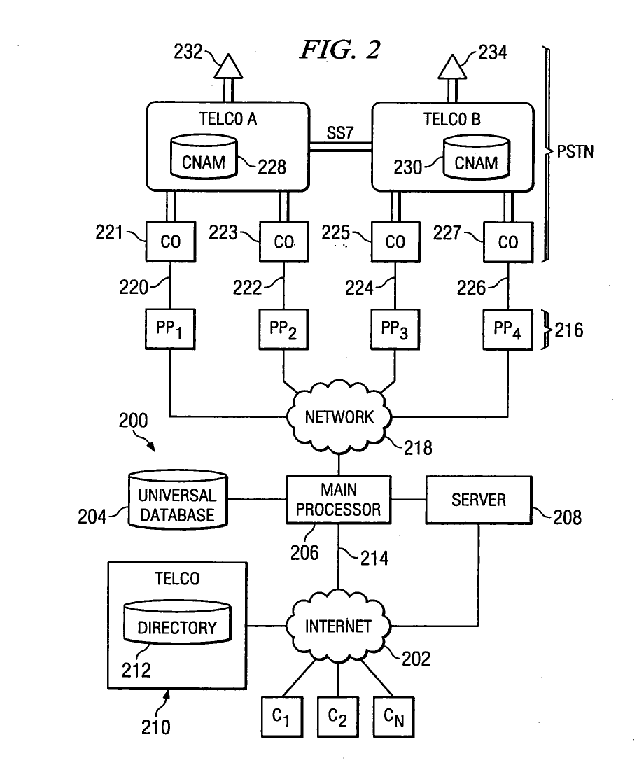

Now referring to FIG. 2, a database system, which is designated generally by reference numeral 200, is illustrated together with components of the previously described PSTN and customers connected to the system 200 through the Internet 202. The system 200 is operated by a Database Company and is equipped to serve a large number of customers at the same time. FIG. 2 assumes that three of N total customers of the Database Company are on-line at a particular point in time and designates those customers as C₁, C₂, and C_{N}. Each customer has previously obtained a customer identification number and password that allows it to log on to Database Company's website and conduct searches of the Company's Universal Database 204. The system 200 is controlled and operated by a Main Processor 206. A server 208 accesses the Universal Database 204 under the control of the Main Processor 206 and reports out data stored in the Universal Database 204 to logged-on customers C₁, C₂, and C_{N}. A customer may enter a query about a particular person (by name, address, etc.) to determine the telephone number for that person, if present in the Universal Database 204. A customer may also perform a reverse search by entering a query for a particular telephone number in the NPA-NXX-XXXX format.

Each Telco in the PSTN has its own directory of subscribers in which it lists the name associated with each telephone number in its assigned regions. The Database Company contracts with each Telco to obtain its directory data through the Internet. One such Telco 210 is shown in FIG. 2 by way of example, along with its Directory 212. Typically, each Telco automatically sends its entire directory contents to the Database Company once each business day by File Transfer Protocol (FTP). This occurs through a broadband connection 214 between the Main Processor 206 and the Internet 202. The Database Company preferably stores such directory data in a separate database (not shown), which can be searched by logged-on customers as a directory assistance option.

The Main Processor 206 directs the operation of a group of Peripheral Processors, some of which are identified in FIG. 2 as PP₁, PP₂, PP₃, and PP₄, and collectively designated by numeral 216. The Peripheral Processors 216 and the Main Processor 206 are connected through a Network 218, which preferably is the Internet. The Peripheral Processors 216 are connected to the PSTN and are used to obtain CNAM data from the Telcos, which is then used to update the Universal Database 204.

Telcos offer enhanced connectivity to their subscribers using a high-speed, digital transmission trunk line known as a T1 line. The T1 line multiplexes 24 channels (23 voice and one data) onto a single line, which preferably is a fiber optic cable. Using a standard known as ISDN PRI, the T1 line runs at a signaling speed of 1.544 Mbsp (million bits per second). ISDN PRI stands for Integrated Services Digital Network Primary Rate Interface, and is a common high-speed service offered to PSTN subscribers. An ISDN PRI T1 line allows the subscriber to configure a custom ANI message when an outgoing call is placed through the T1 line. The subscriber can modify the outgoing ANI message by inserting a selected number as the Calling Party Number (CPN). See Example 4 above for an application of this technology in the context of a PBX outgoing call.

Referring again to FIG. 2, the Database Company's system 200 includes ISDN PRI T1 line connections between each Peripheral Processor 216 and a Telco Central Office. PP₁ is connected through T1 line 220 to CO 221, and PP₂ is connected through T1 line 222 to CO 223. Telco A operates CO 221 and CO 223. PP₃ is connected through T1 line 224 to CO 225, and PP₄ is connected through T1 line 226 to CO 227. Telco B operates CO 225 and CO 227. Telco A has a CNAM database 228, and Telco B has a CNAM database 230. Telco A and Telco B represent two of the various Telcos that make up the PSTN, which includes an overlaid SS7 network. Interconnections to other Telcos in the PSTN, as well as to cellular phone service providers and VoIP service providers, is represented by the connection symbols 232 and 234.

As an example of how the Database Company acquires the names of subscribers with unlisted numbers, suppose the Database Company wishes to determine the subscriber name for the number NPA-NXX-1234, which will be referred to as the telephone-number-in-question or TNIQ. This TNIQ is known to be a subscriber number within Telco A's area and the NXX corresponds to CO 221. PP₁ sets up an outgoing call and inserts the number “NPA-NXX-1234” in the CPN field of the ANI message. The ANI message also includes a field for the number called, which is referred to as the DNIS number. DNIS stands for Dialed Number Identification Service, but is commonly known as the destination number of the call.

As an essential feature of the technique used by the Database Company, PP₁ inserts as the DNIS one of the numbers to which the Database Company subscribes. This DNIS number could be a number associated with the same T1 line 220 on which the outgoing call is made. However, as a simplified example, suppose that the DNIS number is on the T1 line 222 connecting PP₂ to CO 223. Then, when the call is placed, and the connection is made between PP₁ and PP₂ through Telco A, CO 223 queries the CNAM database 228 for the name associated with the modified CPN “NPA-NXX-1234,” and receives a name, such as for example, “Tom Discreet.” This occurs despite the fact that Tom Discreet has an unlisted number. Then, CO 223 transmits the Caller ID data “NPA-NXX-1234” and “Tom Discreet” for the CPN and CNAM onto the DNIS incoming line to PP₂. Then, PP₂ records the Caller ID data and then rejects the call, so that the call is terminated as though it was unanswered. Later, PP₂ transmits the Caller ID data through the Network 218 to the Main Processor 206 to be included in the Universal Database 204. By repeating this procedure over and over again as rapidly as outgoing calls can be set up and connected through the PSTN, the Database Company can create and update its Universal Database 204 with subscriber names and numbers that are as accurate as the records in the Telco CNAM databases, even including unlisted numbers.

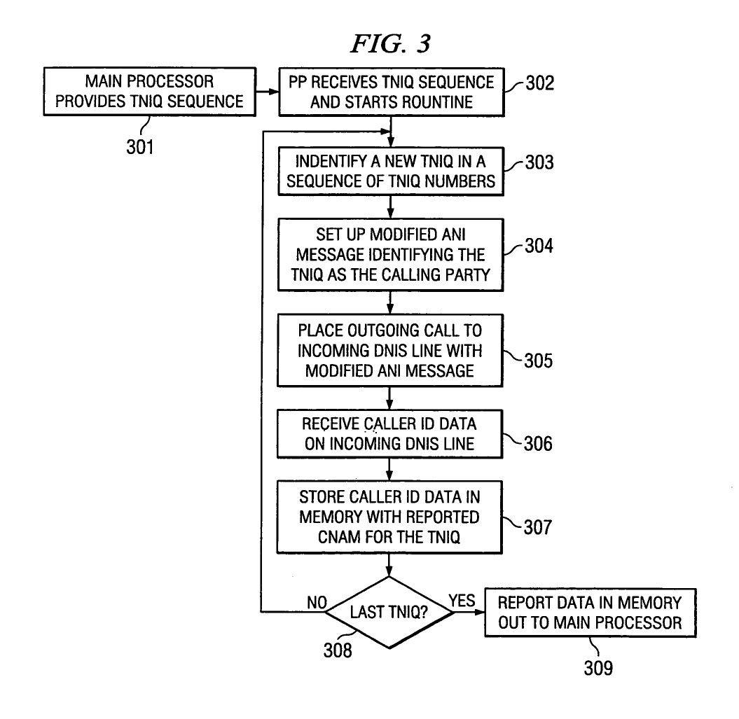

FIG. 3 shows a simplified flowchart for the steps programmed into the Peripheral Processors 216 for generating outgoing calls and gathering Caller ID data for a sequence of telephone-numbers-in-question, or TNIQs, selected by the Main Processor 206. In practice, each PP 216 processes multiple outgoing calls simultaneously through its dedicated T1 line. Thus, the flowchart of FIG. 3 can be considered to apply to a single channel of a T1 line. As understood by those skilled in the art, multiple subscriber lines share a single physical T1 line, which communicates through multiple multiplexed channels. The channels are Time Division Multiplexed (TDM) so that multiple outgoing query calls can be processed simultaneously through a single T1 line. The signaling speed of the T1 line is so fast that a set of outgoing calls can be made virtually in parallel on the T1 line.

The Main Processor 206 identifies a set of NPA-NXX-XXXX numbers for which updated Telco CNAM data is desired. The Main Processor 206 prepares a file of these TNIQ numbers. For example, the Main Processor 206 can create a file of TNIQ numbers for a particular NXX local exchange prefix. This TNIQ file will include all unlisted numbers in that particular NXX prefix. Then, as shown in Step 301, the Main Processor 206 transmits the file of TNIQ numbers through the Network 218 to a selected Peripheral Processor PP of a group of similar such processors. Let us assume for illustration purposes that the selected Peripheral Processor is PP₁ in FIG. 2, which uses its ISDN PRI T1 line 220 to place calls through CO 221 in Telco A's network. The Main Processor 206 prepared the file of TNIQ numbers for processing by PP₁ by selecting numbers in an NXX prefix within Telco A's subscriber base. Therefore, the CNAM data for those numbers, if active listings, will be in Telco A's CNAM database 228.

Step 302 in FIG. 3 shows that the selected PP₁ specifically PP₁ in this example, receives the TNIQ file from the Main Processor 206 and starts its calling routine. Preferably, as an example, all calls are placed to a destination number that is one of the numbers on the same T1 line 220 that is used for the outgoing call. The DNIS number to be used for the incoming call is written into the corresponding field of the outgoing message when each call is placed. In Step 303, PP₁ identifies the next, or initially the first, TNIQ in the TNIQ file and puts it in a predetermined memory location. Then, in Step 304, PP₁ sets up a modified ANI message by loading the TNIQ from the predetermined memory location into a data string that will identify the TNIQ number as the CPN in the modified ANI message. Next, as shown in Step 305, PP₁ places the outgoing call with the modified ANI message.

As explained previously, when a call is placed through an ISDN PRI T1 line with a modified ANI message, and the Called Party has subscribed to Caller ID reporting with its Telco, Caller ID data will be transmitted on the incoming DNIS line between the first and second rings. When CO 221 queries Telco A's CNAM database 228 for the CNAM of the Calling Party, the query uses the CPN that was inserted by PP₁ into the outgoing modified ANI message. Therefore, Telco A reports to CO 221 a CNAM from its database that corresponds to the TNIQ that PP₁ inserted into the CPN field of the modified ANI message. As shown in Step 306, PP₁ receives the Caller ID data on its incoming DNIS line, including the CNAM data for the TNIQ. Then, as shown in Step 307, PP₁ stores the Caller ID data in memory, and then terminates the call. If the TNIQ is an unlisted number, the system has now captured the CNAM data for that unlisted number.

After each call making a TNIQ inquiry is completed, PP₁ checks to see if all TNIQs in the TNIQ file have been searched in the foregoing manner. As shown in Step 308, if the last TNIQ has not been reached, the routine loops back through the “NO” path to Step 303 to cause PP₁ to process another outgoing call on the same T1 channel. On the other hand, if the last TNIQ in the TNIQ file has been reached, the routine branches into a new routine through path “YES” to Step 309. PP₁ then reports the Caller ID data assembled during the search sequence to the Main Processor 206 through the Network 218. Alternatively, PP₁ can hold the CNAM data in its memory for downloading by the Main Processor 206 at a later time.

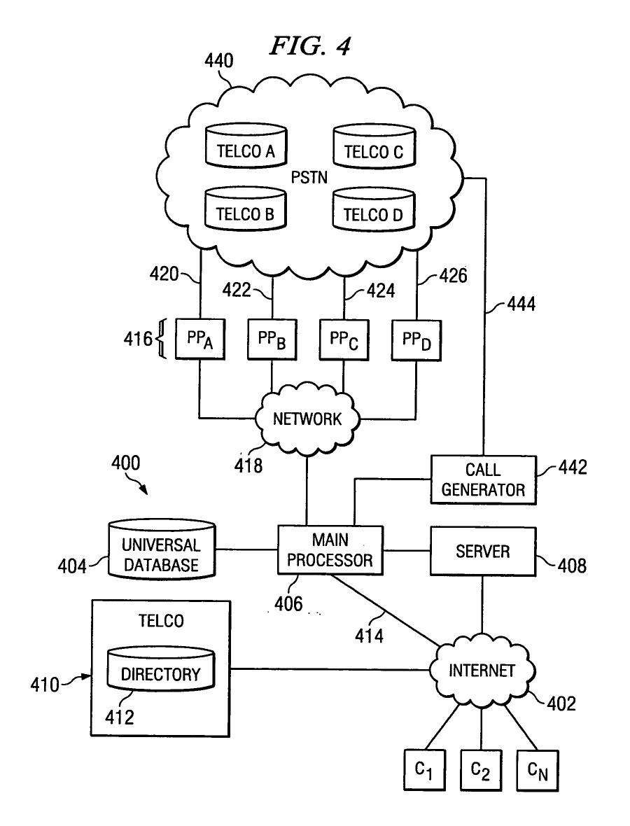

FIG. 4 illustrates another embodiment of the inventive system, designated generally by reference numeral 400. Similar components of the system 400 and the system 200 of FIG. 2 are denoted by similar reference numerals. In system 400 of FIG. 4, all outgoing CNAM query calls to the PSTN 440 are placed by a Call Generator 442, which operates under the control of the Main Processor 406. The Call Generator 442 is connected to at least one Telco within the PSTN 440, preferably through an ISDN PRI T1 line 444. The Main Processor 406 executes a calling routine preferably each business day to obtain updated CNAM data from the Telcos operating within the PSTN 440. This data is stored in the Universal Database 404. The updated Universal Database 404 is accessible by the Database Company's logged-on customers C₁, C₂, and C_{N} through the Internet 402 and Server 408.

Also, as described above in connection with the embodiment of FIG. 2, the system 400 of FIG. 4 can include a separate directory assistance database (not shown) that includes data from Telco directories. For example, Telco 410 transfers its entire subscriber Directory 412 by FTP automatically each business day to the Database Company through the Internet 402 and a broadband connection 414 to the Main Processor 406. Logged-on customers, such as customers C₁, C₂, and C_{N}, can also search this directory data through the Internet 402.

Assume, as a simplified example, that PSTN 440 includes four operating Telcos: Telco A, Telco B, Telco C, and Telco D. Each Telco within the PSTN 440 maintains at least one CNAM database. For ease of illustration, each Telco network and its associated CNAM database is represented by a database symbol within the PSTN 440. The Database Company subscribes to a T1 line from each Telco, and establishes ISDN PRI T1 connections to four Peripheral Processors 416. Peripheral Processor PP_{A} is connected to Telco A through T1 line 420, Peripheral Processor PP_{B} is connected to Telco B through T1 line 422, Peripheral Processor PP_{C} is connected to Telco C through T1 line 424, and Peripheral Processor PP_{D} is connected to Telco D through T1 line 426. Thus, each Telco preferably has a Peripheral Processor subscribing to a T1 line in its service area.

The Peripheral Processors 416 communicate with the Main Processor 406 through a Network 418, which preferably is the Internet. One channel of each T1 line can provide the connection between each Peripheral Processor 416 and the Internet 418. Various remaining channels on each T1 line serve as destination numbers to which the Call Generator 442 places CNAM query calls through the PSTN 440. Various different routines can be used by the system 400 to gather CNAM data from the Telcos operating within the PSTN 440. However, preferably all CNAM query calls are placed to a destination number served by the Telco whose CNAM database will be accessed during the call.

The following example describes a routine for gathering CNAM data using the system 400. The Main Processor 406 prepares a TNIQ file for each Peripheral Processor 416, and matches each TNIQ with a destination number associated with the T1 line serving that Peripheral Processor. The Main Processor 406 directs the Call Generator 442 to execute a calling sequence, which places CNAM query calls to the Peripheral Processors 416, while rotating the calls among the Peripheral Processors in an efficient manner. In placing each CNAM query call, the Call Generator 442 inserts a TNIQ in the CPN field of the outgoing ANI message. A destination number for the Peripheral Processor that is served by the same Telco whose CNAM database will be queried is written into the DNIS field of the outgoing message. When each call is received, the Peripheral Processor records the CNAM data reported on the incoming DNIS line as Caller ID data for the respective TNIQ, and then terminates the call. Periodically during the calling routine, or optionally after the entire calling sequence has been completed, the Peripheral Processors 416 report the Caller ID data to the Main Processor 406 through the Internet 418.

The above-described techniques, or equivalent variations thereof, can be used to obtain caller ID data from the Telco CNAM databases. Such data can be used to provide a more comprehensive database of telephone number subscriber identities than is typically available through directory assistance.

Although preferred embodiments of the invention have been described in detail, it will be understood that various changes, substitutions, and alterations can be made therein without departing from the spirit and scope of the invention as defined by the appended claims.

What is claimed is:

1. A system for creating and maintaining a universal database of telephone numbers and associated subscriber data within a public switched telephone network that includes at least two interconnected telephone companies, each of which operates multiple local exchanges, each telephone company having a Caller ID with name (CNAM) database that can be queried by a local exchange to identify the name of a subscriber corresponding to the Calling Party Number (CPN) of a call being processed for connection to a destination number serviced by the local exchange, comprising:
a main processor;
a universal database for storing telephone numbers and associated subscriber data including the name of each subscriber corresponding to each telephone number;
a group of peripheral processors;
a network interconnecting the main processor with each peripheral processor and permitting communication of signals between the main processor and each peripheral processor; and
a high-speed connection between each peripheral processor and a servicing local exchange, the high-speed connection being capable of serving multiple multiplexed subscriber lines and carrying data in message fields used in call processing by the servicing local exchange, the telephone companies, and other local exchanges within the public switched telephone network, the message fields including a subscriber-modifiable field for identifying the CPN, permitting a subscriber placing a call to insert a selected telephone-number-in-question (TNIQ) in the CPN field of an outgoing call;
wherein the system is configured to execute CNAM query calls, each call being placed to a destination telephone number that is associated with a subscriber line connected to a peripheral processor, and each call including inserting the selected TNIQ into the CPN field of the outgoing call-processing message;
whereby the system can obtain the names in telephone company CNAM databases associated with selected TNIQ subscriber numbers as Caller ID data transmitted to the system's destination number subscriber lines.

2. The system of claim 1 wherein the CNAM query calls are placed by the peripheral processors.

3. The system of claim 1 further comprising a call generator operating under the control of the main processor, and a high-speed connection between the call generator and a telephone company, wherein the CNAM query calls are placed by the call generator.

4. The system of claim 1 further comprising a server that provides access to the universal database to logged-on customers through the Internet.

5. A method for creating and maintaining a user-searchable database of telephone numbers and associated subscriber data for a public switched telephone network (PSTN), the PSTN including telephone companies that provide Caller ID services and maintain Caller ID with name (CNAM) databases that include subscriber names associated with subscriber numbers, the telephone companies permitting subscribers to certain high-speed connections to set up outgoing call-processing messages that include a Calling Party Number (CPN) field and destination number field, the method comprising:
(a) setting up a call to a destination number in which a selected telephone-number-in-question (TNIQ) is inserted into the CPN field of the outgoing call-processing message;
(b) placing the call to the destination number;
(c) once the call has been connected, receiving Caller ID data corresponding to the subscriber whose number is the TNIQ as stored in a CNAM database;
(d) storing the Caller ID data for the TNIQ;
(e) repeating steps (a) through (d) for a series of TNIQs; and
(f) recording the stored Caller ID data for the series of TNIQs in the user-searchable database.

6. The method of claim 5 in which the destination number and TNIQ for each call are subscriber numbers serviced by the same telephone company.

7. The method of claim 6 further comprising receiving search queries from logged-on customers through Internet access for searching the user-searchable database, and reporting the results of each search query to the respective customer.
